(19) United States
(12) Patent Application Publication
(10) Pub. No.: US 2020/0372796 A1
(43) Pub. Date: Nov. 26, 2020

(54) METHOD, APPARATUS, AND SYSTEM FOR COLLECTING AND PROVIDING ROUTE-RELATED INFORMATION BASED ON CITIZEN BAND RADIO

(71) Applicant: HERE GLOBAL B.V., Eindhoven (NL)

(72) Inventor: Buddika GAJAPALA, Naperville, IL (US)

(21) Appl. No.: 16/419,878

(22) Filed: May 22, 2019

(51) Int. Cl. G08G 1/0967; G08G 1/09; G10L 15/26; G10L 15/18

(52) U.S. Cl. CPC G08G 1/096791; G10L 15/18; G10L 15/265; G08G 1/091

(57) ABSTRACT

An approach is provided for collecting and providing up-to-date route-related information based on voice-activated CB radio communications. The approach involves capturing, by device, a citizen band (CB) radio communication from a user as an audio sample. The approach also involves processing the audio sample into text using speech recognition. The approach further involves processing the text using natural language processing (NLP) to detect content. The approach further involves transmitting the content to a server, wherein the server distributes the content to one or more other users. The approach also involves the server receiving one or more messages from one or more devices, storing the one or more messages at a central server, and distributing the one or more messages from the central server to one or more other devices.

### BACKGROUND

Providing up-to-date route-related information (e.g., traffic conditions, accidents, parking availability, etc.) to users of vehicles planning to travel or traveling on a road network is an important function for navigation and mapping service providers. For example, knowing real-time road conditions and/or situations in route to a destination and/or the availability of parking at the destination can have a significant impact on a user's trip planning, routing, and/or estimated time of arrival. One popular means of communicating such information, particularly among long-haul truck drivers, is citizen band (CB) radio. However, CB radio has a limited range (e.g., 3-4 miles) and, therefore, users beyond that distance may not receive the information. In addition, CB radio is an analog (non-digital) radio transmission, which is susceptible to a high signal-to-noise ratio (i.e., interference) and is difficult to automate. Further, CB radio lacks scalability in that users cannot listen to multiple CB channels at the same time and, therefore, may miss useful information being shared on another channel.

### SOME EXAMPLE EMBODIMENTS

Therefore, there is a need for collecting and providing up-to-date route-related information based on voice-activated CB radio communications.

According to one embodiment, a computer-implemented method comprises capturing, by device, a CB radio communication from a user as an audio sample. The method also comprises processing the audio sample into text using speech recognition. The method further comprises processing the text using natural language processing (NLP) to detect content. The method further comprises transmitting the content to a server, wherein the server distributes the content to one or more other users.

According to another embodiment, an apparatus comprising at least one processor, and at least one memory including computer program code for one or more computer programs, the at least one memory and the computer program code configured to, with the at least one processor, cause the apparatus, at least in part, to receive one or more messages from a one or more devices, wherein the one or more messages are generated by capturing a CB radio communication as an audio sample, wherein the audio sample is processed to detect content using NLP by the one or more devices, and wherein the one or more messages are generated to include the content. The apparatus is also caused to store the one or more messages at a central server. The apparatus is further caused to distribute the one or more messages from the central server to one or more other devices.

According to another embodiment, a non-transitory computer-readable storage medium carrying one or more sequences of one or more instructions which, when executed by one or more processors, cause, at least in part, an apparatus to perform capturing, by device, a CB radio communication from a user as an audio sample. The apparatus is also caused to perform processing the audio sample into text using speech recognition. The apparatus is further caused to perform processing the text using NLP to detect content. The apparatus is further caused to perform transmitting the content to a server, wherein the server distributes the content to one or more other users.

According to another embodiment, an apparatus comprises means for capturing, by device, a CB radio communication from a user as an audio sample. The apparatus also comprises means for processing the audio sample into text using speech recognition. The apparatus further comprises means for processing the text using NLP to detect content. The apparatus further comprises means for transmitting the content to a server, wherein the server distributes the content to one or more other users.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of collecting and providing up-to-date route-related information based on voice-activated CB radio communications, according to one embodiment;

FIG. 2 is a diagram of the components of a notification platform/notification module, according to one embodiment;

FIG. 3 is a flowchart of a device-side process for collecting route-related information based on voice-activated CB radio communications, according to one embodiment;

FIG. 4 is a flowchart of a server-side process for providing route-related information based on voice-activated CB radio communications, according to one embodiment;

FIG. 5 is a diagram illustrating an example architecture for collecting and providing route-related information based on voice-activated CB radio communications, according to one embodiment;

FIG. 6 is a diagram of an example user interface for collecting route-related information based on voice-activated CB radio communications, according to one embodiment;

FIGS. 7A and 7B are diagrams of example user interfaces for providing route-related information based on voice-activated CB radio communications, according to one embodiment;

FIG. 8 is a diagram of a geographic database, according to one embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset or vehicle or part thereof) that can be used to implement an embodiment of the invention.

### DESCRIPTION OF SOME EMBODIMENTS

Examples of a method, apparatus, and computer program for collecting and automatically providing route-related information based on voice-activated CB radio communications are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

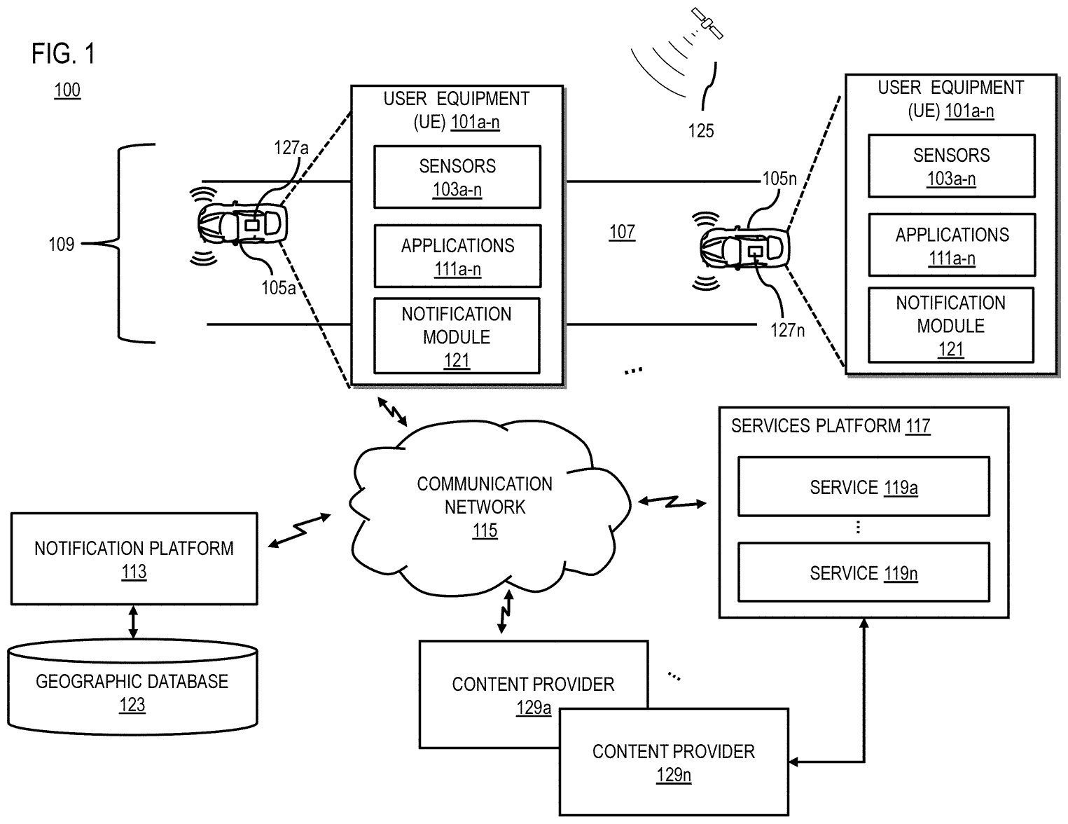

FIG. 1 is a diagram of a system capable of collecting and providing up-to-date route-related information to a user (e.g., a long-haul truck driver) based on voice-activated CB radio communications. As described above, knowing real-time road conditions and/or situations in route to a destination and/or the availability of parking at the destination can have a significant impact on a user's trip planning, routing, and/or estimated time of arrival. However, obtaining up-to-date route-related information, particularly real-time information, is particularly challenging. For example, service providers often leverage municipality dispatches (e.g., road closure reports), web scrapings, police reports, local news, etc. to determine route-related information. However, this information can quickly become out of date and, therefore, not particularly useful. Moreover, the information from these sources is often limited to popular roads and highways and, therefore, the information is difficult to scale to the vast road network commonly experienced today. Further, trying to update and/or adapt this information in real time may require considerable human interaction (e.g., human observation and/or verification).

One popular approach to communicating route-related information, particularly among long-haul truck drivers, is CB radio. For example, a driver may use her/his CB radio to let another driver know that there is a police speed trap on the road or route that the driver is driving or on a road or route that the driver can observe or that an accident is causing a considerable traffic delay and, therefore, other drivers may want to consider alternative routes and/or plan accordingly. However, effective communication using CB radio poses many challenges. First, CB radio has a limited range (e.g., 3-4 miles). Therefore, users beyond this range may not receive the transmitted information. Second, CB radio is an analog (non-digital) transmission, which is susceptible to high signal-to-noise ratio (i.e., interference) and is difficult to automate. Third, CB radio lacks scalability in that users cannot listen to multiple CB channels at the same time and, therefore, may miss useful information being shared on another channel. Last, because CB radio has a limited number of channels (e.g., 40), the channels often become “crowded” with information, making quickly discerning what, when, and where an incident or event is happening a considerable challenge.

To address these technical problems, a system 100 of FIG. 1 introduces a capability to collect and to provide up-to-date (e.g., real time) route-related information to a user (e.g., a long-haul truck driver) based on voice-activated CB radio communications, according to one embodiment. In one embodiment, the system 100 includes one or more user equipment (UE) 101a-101n (also collectively referred to herein as UEs 101) (e.g., a CB radio) having one or more device sensors 103a-103n (also collectively referred to herein as device sensors 103) (e.g., a microphone) that can capture a user talking or speaking into a UE 101 while driving one or more vehicles 105a-105n (also collectively referred to herein as vehicles 105) (e.g., a long-haul truck) on a road or route 107 of a road network 109. By way of example, a user may be driving a long-haul truck on the route 107, notice a speed trap along the route, and want to warn other users of this fact. In this instance, the user might say into her/his CB radio 101 “speed trap on route 107 northbound near mile marker 56.”

In one embodiment, the system 100 converts the user's speech (e.g., “speed trap on route 107 northbound around mile marker 56”) into text using one or more applications 111a-111n (also collectively referred to herein as applications 111) (e.g., a Speech to Text application) of the UEs 101. In one embodiment, the system 100 then processes the text using one or more applications 111 (e.g., a Natural Language Processing (NLP) application) to detect meaningful route-related content. By way of example, the meaningful content may pertain to traffic, truck parking information, accidents, or even abnormal driving behavior (e.g., an unstable or erratic driver). In this example, the system 100 may use an NLP application 111 to detect meaningful content such as “speed trap,” “northbound,” and “mile marker 56.”

In one embodiment, the UEs 101 also have connectivity to a notification platform 113 via the communication network 115. In one embodiment, the notification platform 113 may be a cloud-based platform that collects and processes voice or spoken CB radio communications (e.g., a user's observation or warning). In one instance, the notification platform 113 can perform the speech to text conversion and/or NLP processing to minimize the cost and footprint of a UE 101 (e.g., a smart CB radio). In one embodiment, the notification platform 113 has connectivity over the communication 115 to the services platform 117 (e.g., an OEM platform) that provides one or more services 119a-119n (also collectively referred to herein as services 119) (e.g., speech transcription and/or NLP services). Alternatively, or in addition, in one embodiment, one or more services 119 (e.g., a voice-activated cloud-based service) can also perform the speech to text conversation and/or NLP processing to minimize the cost and footprint of a UE 101.

In one embodiment, the UEs 101 include a notification module 121 to transmit the meaningful route-related content to the notification platform 113 via the communication network 115. In one embodiment, the message generated by the system 100 and transmitted by the notification module 121 comprises the following structure:
Device ID
location (longitude (Lon), latitude (Lat)) (e.g., picked up from GPS sensors 103)
Text message (e.g., “speed trap . . . northbound . . . mile marker 56”)
NLP derived features (e.g., tags and/or key words)
Boolean flags (e.g., indicating whether the message originated from a microphone 103 of a UE 101 (e.g., a CB Radio) as opposed to a speaker of a UE 101)
   In one embodiment, the transmitted message may also include a time stamp (e.g., based on a GPS sensor 103). In one instance, the notification module 121 also includes cellular radio capabilities (e.g., general packet radio service (GPRS) or global system for mobile communications (GSM) capabilities) for transmitting the message via a cellular data network (e.g., the communication network 115).

In one embodiment, the system 100 receives one or more messages from multiple sources (e.g., multiple CB radios 101 listening to the same channel and sending messages). In one embodiment, the system 100 can combine the one or more received messages based on the text message (or hash generated out of it) (e.g., “speed trap on route 107 northbound near mile mark 56”) and approximate time stamps to derive the approximate location of the original source (e.g., northbound on route 107). In one instance, if one of the messages includes location information (e.g., a “broadcaster” flag set location, GPS coordinates, etc.), then the system 100 can determine the location of the one or more other messages based on that location rather than based on an approximation.

In one instance, the system 100 can derive higher order scenarios based on receiving multiple unique messages transmitted at approximately the same time from approximately the same location to generate additional alerts. In other words, in one embodiment, the system 100 can determine a pattern (e.g., a multiple vehicle accident, a tractor trailer accident wherein the vehicle contents have been spilled on the road, etc.) based on the reception of the multiple unique messages. By way of example, a higher order scenario may include hot spots, accident information, truck parking availability, etc.

In one embodiment, the system 100 streams one or more location specific alerts to other UEs 101 (e.g., CB radios) via the communication network 115. In one instance, the system 100 can transmit or broadcast an alert to a user via an application 111 (e.g., a messaging or alert application) rather than through a channel of a CB radio. As a result, the system 100 can transmit or broadcast an alert to a user even though that user is not turned to the channel that another user used to broadcast the incident. Consequently, the system 100 can collect actionable and automatable information from human communication over a CB radio; can extend the range of information from a few miles to any distance; and can process the information to generate higher order patterns (e.g., accident information).

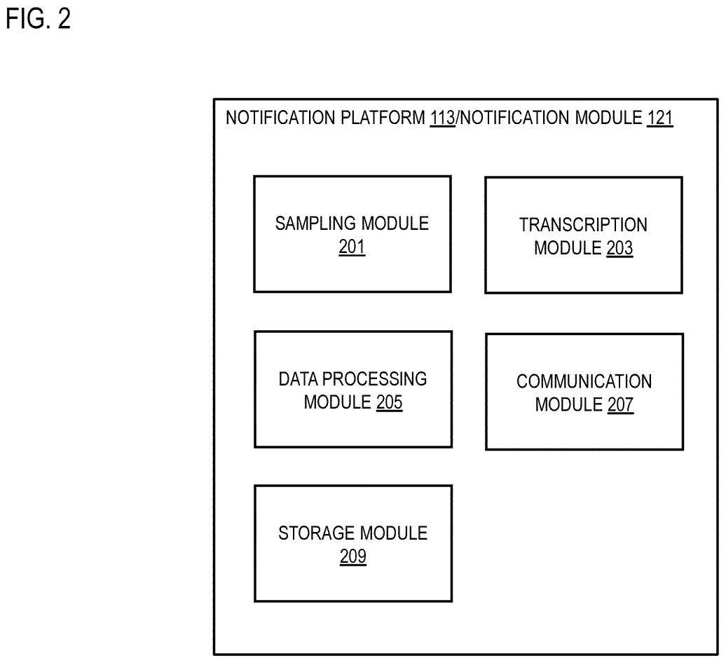

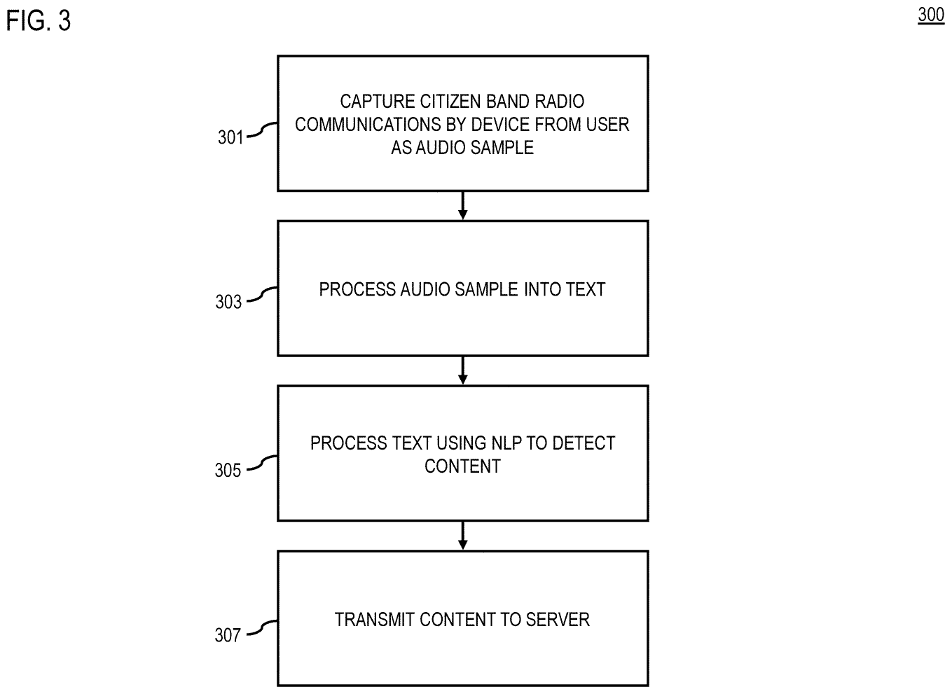

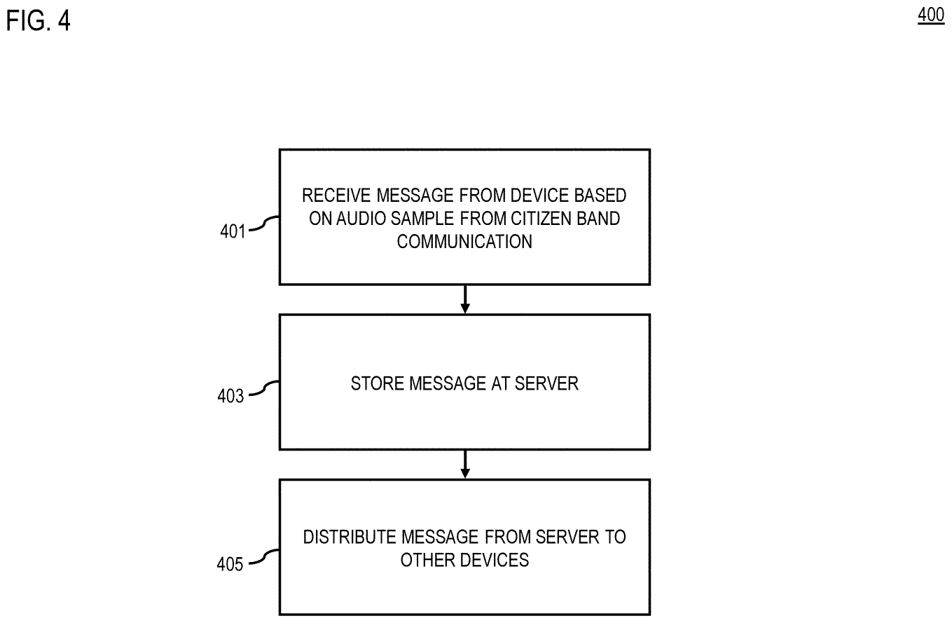

FIG. 2 is a diagram of the components of the notification platform 113 and/or notification module 121, according to one embodiment. In one embodiment, the notification module 121 can perform all or a portion of the functions of the notification platform 113 alone or in combination with the notification platform 113. By way of example, the notification platform 113 and/or the notification module 121 includes one or more components for collecting and providing route-related information based on voice-activated CB radio communications. It is contemplated that the functions of these components may be combined in one or more components or performed by other components of equivalent functionality. In one embodiment, the notification platform 113 and/or the notification module 121 includes a sampling module 201, a transcription module 203, a data processing module 205, a communication module 207, and a storage module 209. In one embodiment, the notification platform 113 has connectivity to the geographic database 123. The above presented modules and components of the notification platform 113 and/or notification module 121 can be implemented in hardware, firmware, software, or a combination thereof. Though depicted as separate entities in FIG. 1, it is contemplated that the notification platform 113 and/or the notification module 121 may be implemented as a module of any of the components of the system 100. In another embodiment, the notification platform 113, the notification module 121, and/or one or more of the modules 201-209 may be implemented as a cloud-based service, local service, native application, or combination thereof. The functions of the notification platform 113, the notification module 121, and/or the modules 201-209 are discussed with respect to FIGS. 3 and 4 below.

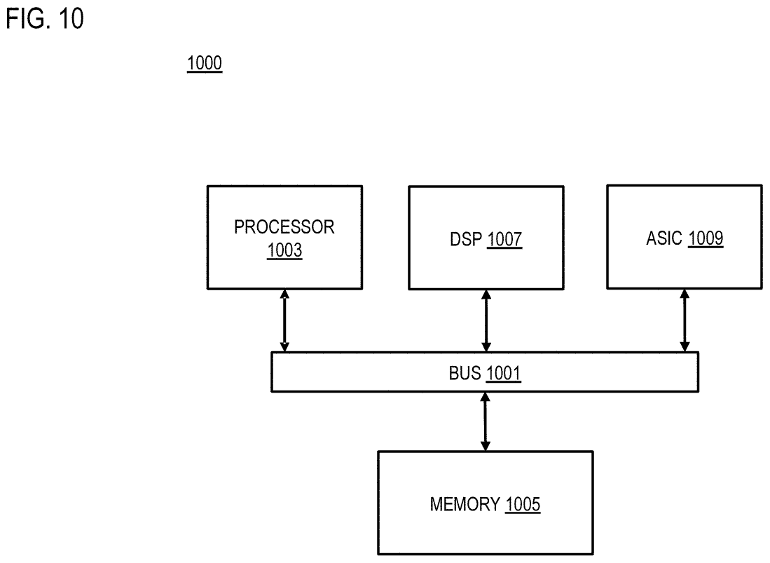

FIG. 3 is a flowchart of a device-side process for collecting route-related information based on voice-activated CB radio communications, according to one embodiment. In various embodiments, the notification platform 113, the notification module 121, and/or the modules 201-209 as shown in FIG. 2 may perform one or more portions of the process 300 and may be implemented in, for instance, a chip set including a processor and a memory as shown in FIG. 10. As such, the notification platform 113, the notification module 121, and/or the modules 201-209 can provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 may be performed in any order or combination and need not include all of the illustrated steps.

In step 301, the sampling module 201 captures, by device, a CB radio communication from a user as an audio sample. By way of example, the device may be a CB radio, a smart CB radio, or a combination thereof capable of capturing human audio communications (e.g., a vocal or spoken communication). In one embodiment, a smart CB comprises a CB radio that has been enhanced by integrating a GPS unit that determines a location related to the broadcasted content. By way of example, the CB radio communication may be a verbal or vocal observation, statement, warning, etc. that a user wants to share, convey, or broadcast with one or more other users. For example, a user may want to notify other drivers that there is an accident on the road or route that the user is driving or on a road or route that the user can observe from her/his location. By way of example, a user may be a driver or a passenger of a vehicle (e.g., a long-haul truck) or an individual that is able to observe road conditions and/or situations in real time and that wants to share such information with others. In one instance, the audio sample may be an analog audio file, a digital audio file, or a combination thereof.

In step 303, the transcription module 203 processes the audio sample (e.g., a verbal or spoken observation) into text using speech recognition. By way of example, the transcription module 203 can processes the audio sample using speech to text, automatic speech recognition, computer speech recognition, or the like. For example, a user of a vehicle may be driving on a roadway and notice an accident that she/he wants to warn other subsequent drivers about. In one embodiment, the transcription module 203 can process the user's voice or spoken statement captured by the sampling module 201 into text (e.g., “be alert accident at mile marker 56 likely to cause traffic delay”). In one embodiment, the transcription module 203 may be trained while processing audio samples into text such that it may iteratively process the audio sample more effectively over time.

In step 305, the data processing module 205 processes the text using NLP to detect content. By way of example, the data processing module 205 may process the text using NLP or any other suitable process for analyzing large amounts of natural language data. In one embodiment, the content includes one or more tags, one or more key words, or a combination thereof determined by the NLP. By way of example, a tag may comprise a part-of-speech (POS) (e.g., a verb, a noun, a adjective, etc.) to assist the data processing module 205 to detect meaningful content among the text message. In one instances, a key word (e.g., “accident,” “mile marker 56,” “delay,” etc.) may be word or term remaining in the transcribed spoken statement after the data processing module 205 removes commonly used words (e.g., “at,” “and,” “likely”). In one embodiment, the data processing module 205 can calculate or determine the degree of similarity among the key words to derive the relevant content of the text message. In one instance, the content relates to traffic information, truck parking conditions, accident information, information on other drivers (e.g., erratic or dangerous driving behavior), road condition information (e.g., a permanent or temporary road closure), or a combination thereof. In one embodiment, the data processing module 205 may use a machine learning model (e.g., a support vector machine (SVM), a neural network, decision tree, etc.) to automatically or predictively process the text using NLP.

In step 307, the notification module 121 transmits the content to a server (e.g., the notification platform 113), wherein the communication module 207 distributes the content to one or more other users. By way of example, the server may be a central server (e.g., the notification platform 113), a third-party server (e.g., a server associated with a third-party service 117), or a combination thereof. In one embodiment, the notification module 121 generates a message comprising an identifier of the device (e.g., CB radio XYZ), a sensed location of the device (e.g., a GPS coordinate, route 107, etc.), one or more tags, one or more key words, a timestamp, a Boolean flag (e.g., indicating whether the message originates from a CB microphone or a speaker) or a combination thereof, wherein the content is transmitted to the server (e.g., the notification platform 113) using the message. In one instance, the notification module 121 transmits the content to a server (e.g., the notification platform 113) or the content is distributed from a server (e.g., the notification platform 113) using a messaging protocol. In one embodiment, the messaging protocol is a short messaging service (SMS) protocol.

In one embodiment, the server (e.g., the notification platform 113) distributes the content to the one or more other users (e.g., a second driver of a long-haul truck) via an application executing on a receiving device (e.g., a navigation application 111), a display device with connectivity to a CB radio system, or a combination thereof. By way of example, the one or more other users may be other travelers on or near a given road or route, other interested individuals or observers (e.g., news reporters, municipal workers, etc.), or a combination thereof. For example, the other travelers may be drivers or passengers that are currently traveling on the given road or route or they may be planning to travel on the given road or route shortly. In one embodiment, the communication module 207 distributes the content to other users (e.g., long-haul truck drivers) as an alert message (e.g., “warning police speed trap on Interstate 95 northbound around mile marker 56.”) In one instance, the communication module 207 distributes the content to other users based on one or more filters selected by the one or more other users. For example, a long-haul truck driver may set a filter on her/his UE 101 (e.g., a CB radio) for “speed traps,” “accidents,” and “road closures” and a news reporter may set a filter on her/his UE 101 (e.g., a mobile device) for “accidents” and “road closures.”

FIG. 4 is a flowchart of a server-side process for providing route-related information based on voice-activated CB radio communications, according to one embodiment. In various embodiments, the notification platform 113, the notification module 121, and/or the modules 201-209 as shown in FIG. 2 may perform one or more portions of the process 400 and may be implemented in, for instance, a chip set including a processor and a memory as shown in FIG. 10. As such, the notification platform 113, the notification module 121, and/or the modules 201-209 can provide means for accomplishing various parts of the process 400, as well as means for accomplishing embodiments of other processes described herein in conjunction with other components of the system 100. Although the process 400 is illustrated and described as a sequence of steps, it is contemplated that various embodiments of the process 400 may be performed in any order or combination and need not include all of the illustrated steps.

In step 401, the communication module 207 receives one or more messages from a one or more devices (e.g., a CB radio), wherein the one or more messages are generated by capturing a CB radio communication as an audio sample (e.g., an audio file), wherein the audio sample is processed to detect content using NLP by the one or more devices (e.g., a UE 101), and wherein the one or more messages are generated to include the content. In one embodiment, the communication module 207 receives the one or more messages from the notification module 121 of a UE 101 (e.g., a CB radio) over a cellular data network (e.g., the communication network 115) using a messaging protocol (e.g., SMS), as described in step 307 above. In other words, in step 401, the communication module 207 receives the one or more messages generated on the device side as described with respect to FIG. 3.

In one embodiment, the one or more received messages include one or more contextual parameters. In one instance, the one or more contextual parameters include a timestamp associated with the CB radio communication, a location associated with the CB radio communication, or a combination thereof. As described above, a timestamp, a location, or a combination thereof associated with the message may be based on information or data from a device sensor 103 (e.g., a GPS sensor) associated with the CB radio 101 that transmitted the one or more messages received by the communication module 207.

In step 403, the storage module 209 stores the one or more messages at a central server (e.g., a message repository). In one instance, the storage module 209 can store the one or more messages in the geographic database 123. In one embodiment, the data processing module 205 can group the one or more messages stored at the central server (e.g., in the geographic database 123) into a single message based on one or more contextual parameters. By way of example, the data processing module 205 may group all the messages that include a similar location (e.g., on or near route 107). In another example, the data processing module 205 may group the one or more messages based on a further level of granularity (e.g., on or near route 107 at a time of day, a day of the week, etc.).

In one embodiment, wherein the one or more messages (e.g., stored at the notification platform 113, the geographic database 123, or a combination thereof) include a plurality of unique messages, the data processing module 205 can derive a higher order scenario message content based on the plurality of unique messages. In one embodiment, the data processing module 205 can determine the higher order scenario message content based on one or more determined patterns among the messages (e.g., a hot spot, an accident, truck parking availability, etc.). By way of example, the sampling module 201 may capture that multiple long-haul trucks recently pulled out of a truck rest station based on CB radio communications. In one embodiment, the data processing module 205 can then determine from among these unique messages that truck parking spaces may be available at the location from where and when the communications originated.

In step 405, the communication module 207 distributes the one or more messages from the central server (e.g., the notification platform 113) to one or more other devices (e.g., CB radios 101). In one embodiment, wherein the data processing module 205 groups the one or more messages into a single message, as described above, the communication module 207 can distribute the single message to the one or more other devices (e.g., CB radio, mobile device, embedded navigation system, etc.). In one instance, wherein the data processing module 205 derives a higher order scenario message content, as described above, the communication module 207 can transmit the higher order scenario message content to one or more other devices (e.g., CB radio, mobile device, embedded navigation system, etc.).

In one embodiment, the data processing module 205 generates one or more location-specific alerts based on one or more messages, wherein the one or more messages are distributed by the communication module 207 to the one or more other devices (e.g., CB radio, mobile device, embedded navigation system, etc.) as one or more location-specific alerts. In one instance, the one or more location-specific alerts are transmitted by the communication module 207 as a location-specific stream to the one or more other devices (e.g., CB radio, mobile device, embedded navigation system, etc.). By way of example, a user (e.g., a truck driver, news reporter, etc.) can use her/his UE 101 to listen to a route 107 stream to learn route-related information pertaining to route 107 (e.g., for navigation, news reporting, estimated time of arrival, etc.).

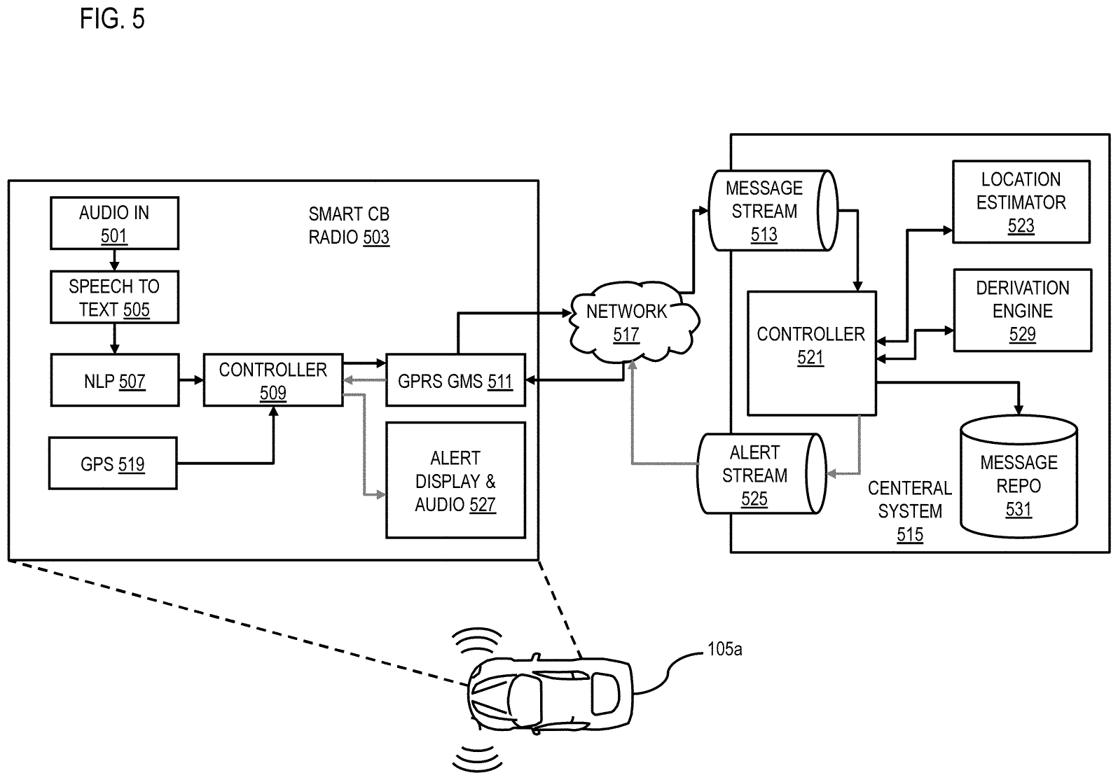

FIG. 5 is a diagram illustrating an example architecture for collecting and providing route-related information based on voice-activated CB radio communications, according to one embodiment. In one embodiment, the information flow begins with the audio in module 501 of a CB radio 503 (e.g., a UE 101) capturing the verbal or spoken statements of a user of the CB radio 503 in the form of an audio sample (e.g., an audio file). In this example, the CB radio 503 is associated with a vehicle 105 (e.g., a long-haul truck), a driver or a passenger of the vehicle 105, or a combination thereof.

In this example, the audio sample is transmitted between the audio in module 501 and the speech to text module 505. The speech to text module 505 converts the user's speech to text (e.g., using speech recognition software) and transmits the text to the NLP module 507. The NLP module 507 processes the text (e.g., using tags, key words, etc.) to detect meaningful content such as traffic, truck parking information, accidents, even abnormal or erratic driving behavior. The NLP module 507 then transmits the meaningful content (e.g., accident route 107 northbound mile marker 56) to a controller 509 (e.g., the notification module 121) that transmits the content to the GPRS GMS module 511 (i.e., a cellular radio module). Thereafter, the GPRS GSM module 511 transmits the content to the message stream module 513 of the central system 515 via the cellular data network 517 (e.g., the communication network 115) using a messaging protocol (e.g., SMS). In this example, a GPS module 519 of the smart CB radio 503 provides location-based information (e.g. location, heading, speed) that is embedded in the content or transmitted along with the content such that the controller 521 (e.g., the notification platform 113) can determine the origin of the information.

In one instance, the controller 521 (e.g., the notification platform 113) streams location specific alerts through the alert stream module 525 to other participating smart CB radios 503 via the cellular data network 517. Thereafter, the controller 509 (e.g., the notification module 121) can display or broadcast the route-related information through the alert display & audio module 527 (e.g., an application 111).

In one embodiment, wherein the content is transmitted to the control module 521 (e.g., the notification platform 113) without location-based information, the location estimator 523 can combine messages received from multiple sources based on the text messages (or hashes generated out of it) and approximate time stamps to derive an approximate location of the original source (e.g., the smart CB radio 503). In one instance, the derivation engine 525 may be used to derive higher order scenarios using multiple unique messages having the same proximity of time and location to generate additional alerts. In one embodiment, the controller module 521 can store information, content, messages, or a combination thereof in the message repository 531 (e.g., the geographic database 123) for further processing. For example, the controller 521 can further process the stored information to generate patterns such as hot spots, accident information, truck parking availability, etc.

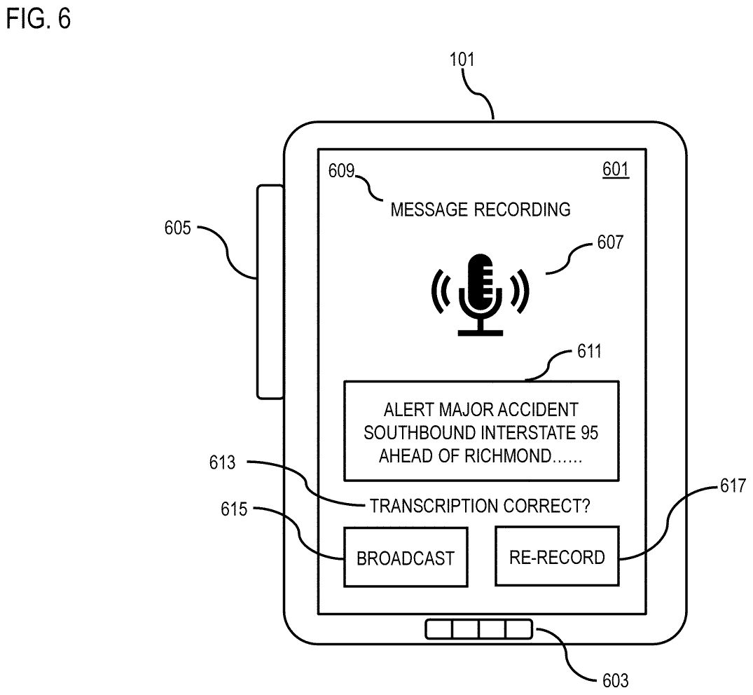

FIG. 6 is a diagram of an example user interface for collecting route-related information based on voice-activated CB radio communications, according to one embodiment. Referring to FIG. 6, a smart CB radio UI 601 (e.g., a messaging application 111) is generated for a UE 101 (e.g., a smart CB radio) that a user (e.g., a long-haul truck driver) can use while driving to warn other drivers on the same road or route of route-related information (e.g., a multicar accident that is likely to cause substantial traffic delays on this road and other connected roads or routes).

In one embodiment, the user can initiate the capturing or recording of her/his voice through a microphone 603 of the UI 601 via an interaction with the input 605. In one instance, the input 605 may be a physical button like that of an ordinary CB radio such that a user can initiate the capture or recording her/his voice by depressing the input 605. In another instance, the input 605 may be a virtual or digital button such that a user can initiate the capture or recording by one or more physical interactions (e.g., a touch, a tap, a gesture, etc.), one or more voice commands (e.g., “CB start recoding”), or a combination thereof. In one instance, once the user initiates the capture or recording, the user can begin speaking in and/or towards the microphone 603. In one embodiment, the system 100 can generate the UI 601 such that it includes a graphic icon 607 (e.g., a microphone, a sound wave, or combination thereof) and a notification 609 (e.g., “message recording”) to alert the user that the UI 601 is recording her/his speech.

In one embodiment, the system 100 can generate the UI 601 such that it displays to the user the conversion of her/his speech to text in real-time or substantially real time (e.g., using speech recognition software, speech to text, etc.), as depicted in the display area 611 of the UI 601. For example, the user might be saying into the microphone 603 “alert major accident southbound Interstate 95 ahead of Richmond.” In one embodiment, the system 100 can generate the UI 601 such that it includes the notification 613 (e.g., “transcription correct”?) to prompt a user to confirm whether her/his verbal statement was transcribed accurately by the system 100. In one instance, the system 100 can generate the UI 601 such that it includes an input 615 (“broadcast”) for when the statement was transcribed accurately and an input 617 (“re-record”) for when the user perceives that there was an error in either her/his statement or in the transcription by the system 100. In one embodiment, the system 100 enables a user to interact with the inputs 615 and 617 through one or more physical interactions (e.g., a touch, a tap, a gesture, etc.), one or more voice-commands (e.g., “CB broadcast” or “CB re-record”), or a combination thereof.

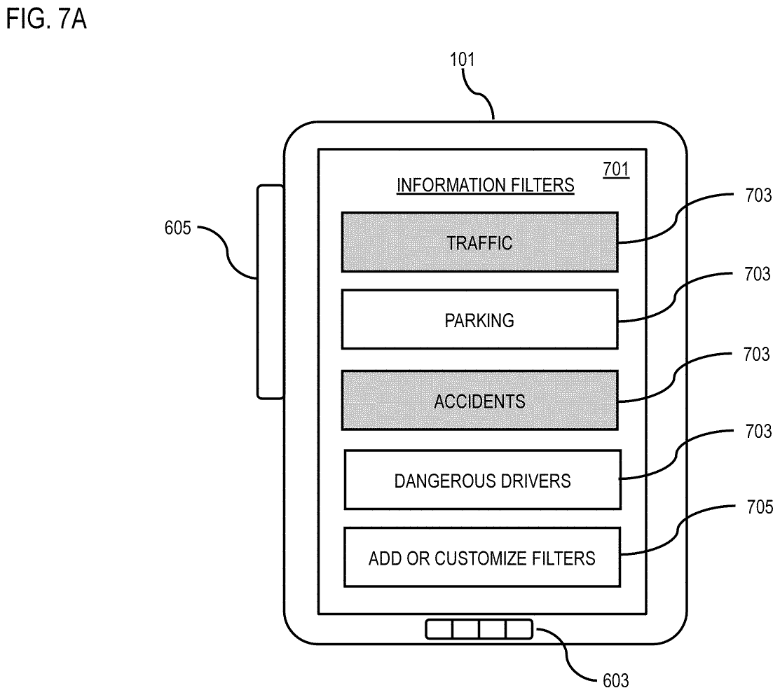

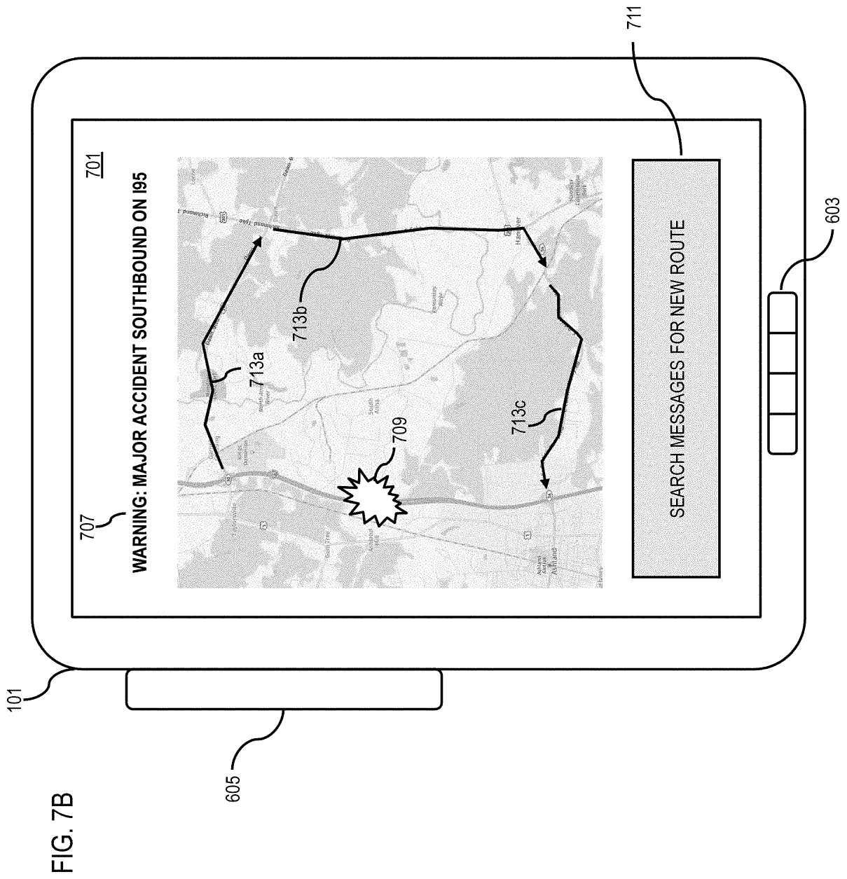

FIGS. 7A and 7B are diagrams of example user interfaces for providing route-related information based on voice-activated CB radio communications, according to one embodiment. In one embodiment, following the example of FIG. 6, the system 100 can generate a smart CB radio UI 701 (e.g., a messaging application 111) for a UE 101 (e.g., a smart CB radio) that a user (e.g., a long-haul truck driver) can use (e.g., while driving) to receive relevant route-related information from another user (e.g., a long-haul truck driver) that may impact her/his trip planning, routing, and/or estimated time of arrival.

Referring to FIG. 7A, in one embodiment, the system 100 can generate the UI 701 such that a user can filter the route-related information collected by the system 100 from one or more other users (e.g., long-haul truck drivers) to ensure that the provided information is relevant and/or desired. In one embodiment, the system 100 can generate the UI 701 such that it includes one or more inputs 703 (e.g., information filters) to enable a user to filter the route-related information collected and/or stored (e.g., in the geographic database 123) by the system 100 at a given time. By way of example, the one or more information filters may include options such as: “traffic,” “truck parking,” “accidents,” “dangerous drivers,” etc. In one instance, the system 100 generates the UI 701 such that it includes an input 705 to enable a user to “add or customize” the one or more information filters. By way of example, a user may want to filter the route-related information based on a specific road or route (e.g., 1-95), a time of day, a day of the week, one or more other contextual parameters, or a combination thereof. In one embodiment, the system 100 enables a user to interact with the inputs 703 and 705 through one or more physical interactions (e.g., a touch, a tap, a gesture, etc.), one or more voice-commands (e.g., “CB traffic” or “CB parking”), or a combination thereof. In this example, the user selected “traffic” and “accident” route-related information.

In one embodiment, the system 100 can generate the UI 701 such that it provides a user (e.g., a long-haul truck driver) with the filtered route-related information (e.g., traffic and accidents) as a location-specific alert, as depicted in FIG. 7B. In one instance, the system 100 can render the verbal message captured or recorded in the example of FIG. 6 (e.g., “alert major accident southbound Interstate 95 ahead of Richmond”) as both a text alert 707 and a graphic alert 709 (e.g., rendered in connection with a mapping/navigation application 111). In one embodiment, the system 100 can render the UI 701 with an input 711 to enable a user to search the message repository of the system 100 (e.g., the geographic database 123) for one or more messages suggesting an alternative route (e.g., routes 713a-713c), which the system 100 can then display and/or provide routing guidance accordingly to the user in the UI 701.

Returning to FIG. 1, in one embodiment, the UEs 101 can be associated with any of the vehicles 105 (e.g., a long-haul truck), a driver or a passenger of the vehicle 105, or an individuals that is able to observe road conditions and/or situations in real time and that wants to share such information to others. By way of example, the UEs 101 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with one or more vehicles or any combination thereof, including the accessories and peripherals of these devices, or any combination thereof. It is also contemplated that a UE 101 can support any type of interface to the user (such as “wearable” circuitry, etc.). In one embodiment, the vehicles 105 may have cellular or wireless fidelity (Wi-Fi) connection either through the inbuilt communication equipment or from a UE 101 associated with the vehicles 105. Also, the UEs 101 may be configured to access the communication network 115 by way of any known or still developing communication protocols. In one embodiment, the UEs 101 may include device sensors 103 (e.g., GPS sensors), applications 111 (e.g., speech to text applications, NPL applications, etc.), and the notification module 121 to collect and to provide route-related information based on voice-activated CB radio communications.

By way of example, the device sensors 103 may include GPS sensors, a microphone, a front facing camera, a rear facing camera, multi-axial accelerometers, height sensors, tilt sensors, wireless network sensors, etc. and the applications 111 may include speech recognition applications, speech to text, NLP applications, messaging applications, mapping applications, routing applications, guidance applications, etc. In one example embodiment, the GPS sensors 103 can enable the UEs 101 to obtain geographic coordinates from satellites 125 for determining the location of the broadcaster of the voice message captured by the UE 101 (e.g., a CB radio). Further, a user location (e.g., a long-haul truck driver) may be determined by a triangulation system such as A-GPS, Cell of Origin, or other location extrapolation technologies when cellular or network signals are available.

In one embodiment, the vehicles 105 are standard transport vehicles (e.g., cars, vans, trucks, etc.) that can be used to transport users (e.g., either as drivers or passengers). In one instance, the vehicles 105 are autonomous or semi-autonomous transport vehicles that can sense their environments and navigate without driver or occupant input via one or more vehicle sensors 127a-127n (also collectively referred to herein as vehicle sensors 127) having connectivity to the notification platform 113, the notification module 121, or a combination thereof via the communication network 115. By way of example, the vehicle sensors 127 may be any type of sensor. In certain embodiments, the vehicle sensors 127 may include, for example, a GPS sensor for gathering location data, temporal information sensors, a camera/imaging sensor for gathering image data, velocity sensors, and the like. In one scenario, the vehicle sensors 127 may detect weather data, traffic information, or a combination thereof. In one example embodiment, the vehicles 105 may include GPS receivers to obtain geographic coordinates from the satellites 125 for determining current or live location and time. Further, the location can be determined by a triangulation system such as A-GPS, Cell of Origin, or other location extrapolation technologies when cellular or network signals are available. In one instance, the system 100 may utilize the device sensors 103 and the vehicle sensors 127 in combination to derive the approximate time and/or location of a spoken message captured or recorded by a UE 101 (e.g., a CB radio). Although the vehicles 105 are depicted as automobiles, it is contemplated that the vehicles 105 may be any type of transportation that a user can drive or ride within as a passenger.

In one embodiment, the notification platform 113 and/or the notification module 121 performs the process for collecting and providing route-related information based on voice-activated CB radio communications as discussed with respect to the various embodiments described herein. In one embodiment, the notification platform 113 can be a standalone server or a component of another device with connectivity to the communication network 115. For example, the component can be part of an edge computing network where remote computing devices (not shown) are installed along or within proximity of an intended destination (e.g., a city center).

In one embodiment, the notification platform 113 and/or the notification module 121 has connectivity over the communication network 115 to the services platform 117 (e.g., an OEM platform) that provides one or more of the services 119. By way of example, the services 119 may also be other third-party cloud-based services and include speech recognition services, NLP services, messaging services, alert notification services, mapping services, navigation services, routing services, social networking services, content (e.g., audio, video, images, etc.) provisioning services, application services, storage services, contextual information determination services, location-based services, information-based services (e.g., weather, news, etc.), etc.

In one embodiment, one or more content providers 129a-129n (also collectively referred to herein as content providers 129) may provide content or data (e.g., traffic information, parking information, accident information, etc.) to the EUs 101, the vehicles 105, the applications 111, the notification platform 113, the services platform 117, the services 119, the notification module 121, and the geographic database 123. The content provided may be any type of content, such as map content, contextual content, audio content, video content, image content, etc. In one embodiment, the content providers 129 may also store content associated with the EUs 101, the vehicles 105, the applications 111, the notification platform 113, the services platform 117, the services 119, the notification module 121, and/or the geographic database 123. In another embodiment, the content providers 129 may manage access to a central repository of data, and offer a consistent, standard interface to data, such as a repository of the geographic database 123.

The communication network 115 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), short messaging service (SMS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the notification platform 113 may be a platform with multiple interconnected components. By way of example, the notification platform 113 may include multiple servers, intelligent networking devices, computing devices, components and corresponding software for collecting and providing route-related information based on voice-activated CB radio communications. In addition, it is noted that the notification platform 113 may be a separate entity of the system 100, a part of the services platform 117, the one or more services 119, or the content providers 129.

In one embodiment, the geographic database 123 stores one or more collected or recorded voice messages transcribed into text, processed by NPL, and transmitted to a server (e.g., the notification platform 113); one or more contextual parameters associated with the one or more messages; one or more grouped messages; one or more higher order scenario message content (e.g., patterns such as hot spots, accidents, truck parking availability, etc.); one or more location-specific alerts; or a combination thereof derived from the UEs 101. The information may be any of multiple types of information that can provide means for collecting and providing route-related information based on voice-activated CB radio communications. In another embodiment, the geographic database 123 may be in a cloud and/or in a UE 101, a vehicle 105, or a combination thereof.

By way of example, the UEs 101, the vehicles 105, the applications 111, the notification platform 113, the services platform 117, the services 119, the notification module 121, the geographic database 123, the satellites 125, the vehicle sensors 127, and the content providers 129 communicate with each other and other components of the communication network 115 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

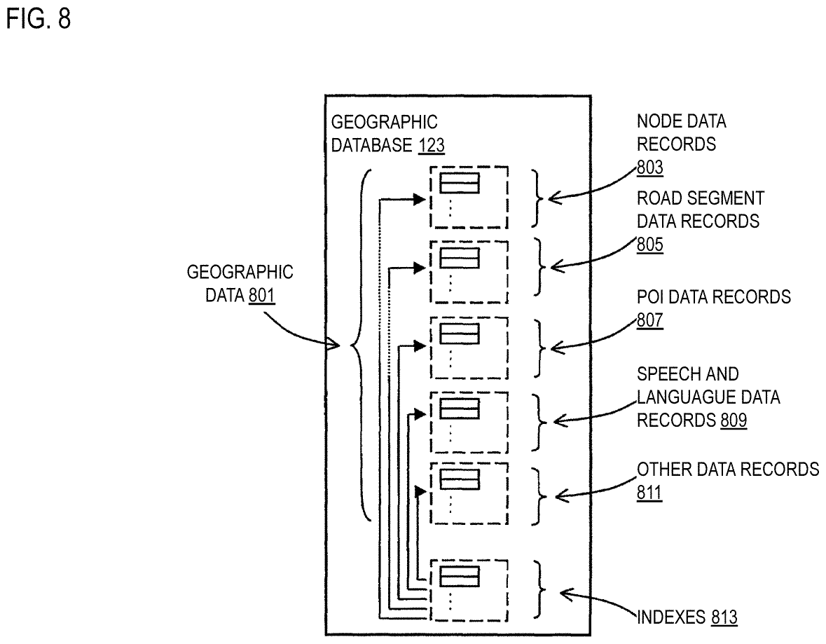

FIG. 8 is a diagram of a geographic database, according to one embodiment. In one embodiment, geographic database 123 includes geographic data 801 used for (or configured to be compiled to be used for) mapping and/or navigation-related services. In one embodiment, geographic features, e.g., two-dimensional or three-dimensional features, are represented using polygons, e.g., two-dimensional features, or polygon extrusions, e.g., three-dimensional features. For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in geographic database 123.

“Node”—A point that terminates a link.

“Line segment”—A straight line connecting two points.

“Link” (or “edge”)—A contiguous, non-branching string of one or more-line segments terminating in a node at each end.

“Shape point”—A point along a link between two nodes, e.g., used to alter a shape of the link without defining new nodes.

“Oriented link”—A link that has a starting node (referred to as the “reference node”) and an ending node (referred to as the “non-reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary, e.g., a hole or island. In one embodiment, a polygon is constructed from one outer simple polygon and none or at least one inner simple polygon. A polygon is simple if it just consists of one simple polygon, or complex if it has at least one inner simple polygon.

In one embodiment, geographic database 123 follows certain conventions. For example, links do not cross themselves and do not cross each other except at a node. Also, there are no duplicated shape points, nodes, or links. Two links that connect each other have a common node. In geographic database 123, overlapping geographic features are represented by overlapping polygons. When polygons overlap, the boundary of one polygon crosses the boundary of the other polygon. In geographic database 123, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 123 includes node data records 803, road segment or link data records 805, POI data records 807, speech and language data records 809, other data records 811, and indexes 813, for example. More, fewer or different data records can be provided. In one embodiment, additional data records (not shown) can include cartographic (“carto”) data records, routing data, and maneuver data. In one instance, the additional data records (not shown) can include common information filter data. In one embodiment, the indexes 813 may improve the speed of data retrieval operations in geographic database 123. In one embodiment, the indexes 813 may be used to quickly locate data without having to search every row in geographic database 123 every time it is accessed. For example, in one embodiment, the indexes 813 can be a spatial index of the polygon points associated with stored feature polygons.

In exemplary embodiments, the road segment data records 805 are links or segments representing roads, streets, or paths, as can be used in the calculated route or recorded route information for determination of one or more personalized routes, an estimated time of arrival, or a combination thereof. The node data records 803 are end points corresponding to the respective links or segments of the road segment data records 805. The road link data records 805 and the node data records 803 represent a road network, such as used by vehicles, cars, and/or other entities. Alternatively, geographic database 123 can contain path segment and node data records or other data that represent pedestrian paths, bicycle paths, or areas in addition to or instead of the vehicle road record data, for example.

The road/link segments and nodes can be associated with attributes, such as functional class, a road elevation, a speed category, a presence or absence of road features, geographic coordinates, street names, address ranges, speed limits, turn restrictions at intersections, and other navigation related attributes, as well as POIs, such as truck and vehicle rest stations or stops, parking lots, gasoline stations, hotels, restaurants, museums, stadiums, offices, automobile dealerships, auto repair shops, buildings, stores, parks, etc. The geographic database 123 can include data about the POIs and their respective locations in the POI data records 807. In one instance, the POI data records 807 can include information regarding popular times at a POI, how long people typically spend at a POI, opening and closing times of a POI, etc. The geographic database 123 can also include data about places, such as cities, towns, or other communities, and other geographic features, such as bodies of water, mountain ranges, etc. Such place or feature data can be part of the POI data records 807 or can be associated with POIs or POI data records 807 (such as a data point used for displaying or representing a position of a city).

In one embodiment, the geographic database 123 can also include speech and language data records 809. In one instance, the speech and language data records 809 may include one or more received or recorded audio samples for training the transcription module 203 to more effectively process audio samples into text. In one embodiment, the speech and language data records 809 may include tags, common key words, or a combination thereof used in NPL. In one instance, the speech and data records 809 may be used by the data processing module 205 in connection with one or more machine learning modules to automatically or predictively process text using NLP.

In one embodiment, geographic database 123 can be maintained by a content provider 129 in association with the services platform 117, e.g., a map developer. The map developer can collect geographic data to generate and enhance geographic database 123. There can be different ways used by the map developer to collect data. These ways can include obtaining data from other sources, such as municipalities or respective geographic authorities. In addition, the map developer can employ field personnel to travel by vehicle (e.g., a vehicle 105) and/or travel with a UE 101 along roads throughout the geographic region (e.g., the road network 109) to observe features and/or record information about them, for example. Also, remote sensing, such as aerial or satellite photography, can be used (e.g., using one or more satellites 125).

The geographic database 123 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a UE 101 or a vehicle 105, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for collecting and providing route-related information based on voice-activated CB radio communications may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

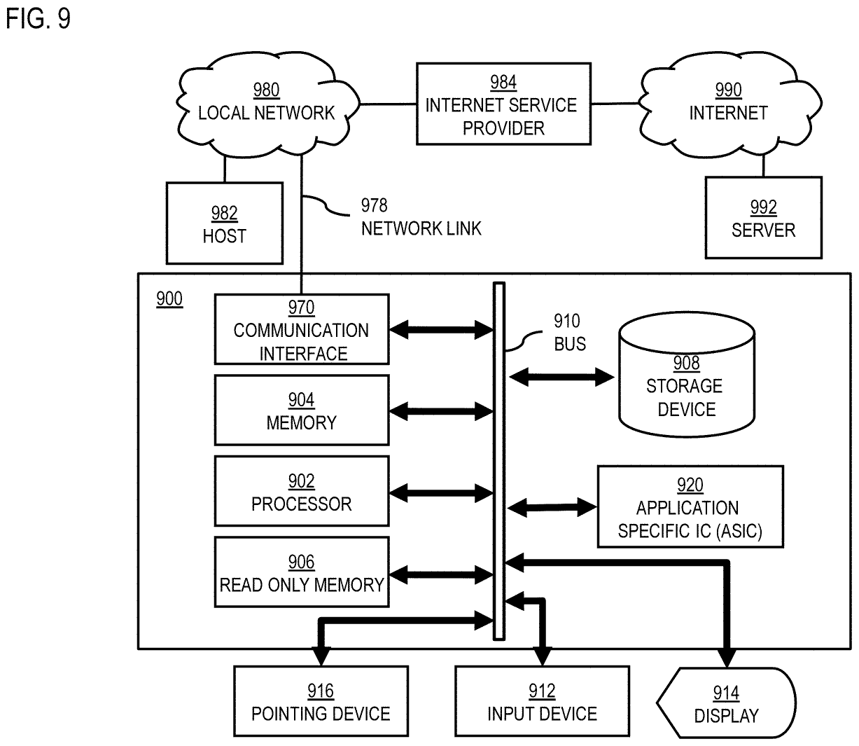

FIG. 9 illustrates a computer system 900 upon which an embodiment of the invention may be implemented. Computer system 900 is programmed (e.g., via computer program code or instructions) to collect and to provide route-related information based on voice-activated CB radio communications as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to collecting and providing route-related information based on voice-activated CB radio communications. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random-access memory (RAM) or other dynamic storage device, stores information including processor instructions for collecting and providing route-related information based on voice-activated CB radio communications. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for collecting and providing route-related information based on voice-activated CB radio communications, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general, the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 115 for collecting and providing route-related information based on voice-activated CB radio communications.

The term non-transitory computer-readable medium is used herein to refer to any medium that participates in providing information to processor 902, including instructions for execution. Such a medium may take many forms, including, but not limited to, non-volatile media, volatile media and transmission media. Non-volatile or non-transitory media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

In one embodiment, a non-transitory computer-readable storage medium carrying one or more sequences of one or more instructions (e.g., computer code) which, when executed by one or more processors (e.g., a processor as described in FIG. 5), cause an apparatus (e.g., the vehicles 101, the UEs 105, the notification platform 113, etc.) to perform any steps of the various embodiments of the methods described herein.

FIG. 10 illustrates a chip set 1000 upon which an embodiment of the invention may be implemented. Chip set 1000 is programmed to collect and to provide route-related information based on voice-activated CB radio communications as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to collect and to provide route-related information based on voice-activated CB radio communications. The memory 1005 also stores the data associated with or generated by the execution of the inventive steps.

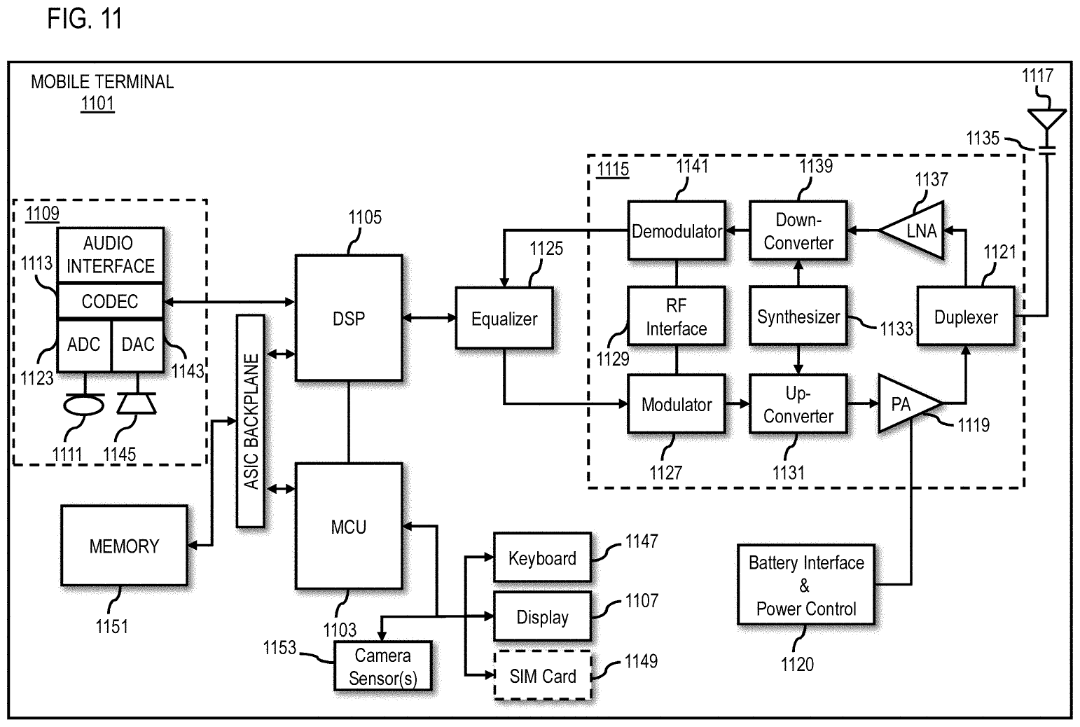

FIG. 11 is a diagram of exemplary components of a mobile terminal 1101 (e.g., handset or vehicle or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions that offer automatic contact matching. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile station 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), WiFi, satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile station 1101 to collect and to provide route-related information based on voice-activated CB radio communications. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile station 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable non-transitory computer readable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile station 1101 on a radio network. The card 1149 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
capturing, by device, a citizen band (CB) radio communication from a user as an audio sample;
processing the audio sample into text using speech recognition;
processing the text using natural language processing (NLP) to detect content; and
transmitting the content to a server,
wherein the server distributes the content to one or more other users.

2. The method of claim 1, wherein the content includes one or more tags, one or more key words, or a combination thereof determined by the NLP.

3. The method of claim 2, further comprising:
generating a message comprising at least one of an identifier of the device, a sensed location of the device, the one or more tags, the one or more key words, a timestamp, a flag indicating that the message originates from a broadcaster of the CB radio communication, or a combination thereof,
wherein the content is transmitted to the server using the message.

4. The method of claim 1, wherein the content is transmitted to the server or distributed from the server using a messaging protocol.

5. The method of claim 4, wherein the messaging protocol is a short messaging service (SMS) protocol.

6. The method of claim 1, wherein the server distributes the content to the one or more other users via an application executing on a receiving device, a display device with connectivity to a CB radio system, or a combination thereof.

7. The method of claim 1, wherein the content relates to traffic information, truck parking conditions, accident information, information on other drivers, road condition information, or a combination thereof.

8. The method of claim 1, wherein the content is distributed to the one or more other users as an alert message.

9. The method of claim 1, wherein the content is distributed to the one or more other users based on one or more filters selected by the one or more other users.

10. An apparatus comprising:
at least one processor; and
at least one memory including computer program code for one or more programs,
the at least one memory and the computer program code configured to, with the at least one processor, cause the apparatus to perform at least the following:
receive one or more messages from a one or more devices, wherein the one or more messages are generated by capturing a citizen band (CB) radio communication as an audio sample, wherein the audio sample is processed to detect content using natural language processing (NLP) by the one or more devices, and wherein the one or more messages are generated to include the content;
store the one or more messages at a central server; and
distribute the one or more messages from the central server to one or more other devices.

11. The apparatus of claim 10, wherein the one or more messages include one or more contextual parameters.

12. The apparatus of claim 11, wherein the one or more contextual parameters include a timestamp associated with the CB radio communication, a location associated with the CB radio communication, or a combination thereof.

13. The apparatus of claim 11, wherein the apparatus is further caused to:
group the one or more messages into a single message based on the one or more contextual parameters,
wherein the single message is distributed from the central server to the one or more other devices.

14. The apparatus of claim 12, wherein the one or more messages include a plurality of unique messages, and wherein the apparatus is further caused to:
derive a higher order scenario message content based on the plurality of unique messages; and
transmitting the higher order scenario message content to the one or more other devices.

15. The apparatus of claim 14, wherein the apparatus is further caused to:
generate one or more location-specific alerts based on the one or more messages,
wherein the one or more messages are distributed to the one or more other devices as the one or more location-specific alerts.

16. The apparatus of claim 15, wherein the one or more or more location-specific alerts are transmitted as a location-specific stream to the one or more other devices.

17. A non-transitory computer-readable storage medium carrying one or more sequences of one or more instructions which, when executed by one or more processors, cause an apparatus to perform:
capturing, by device, a citizen band (CB) radio communication from a user as an audio sample;
processing the audio sample into text using speech recognition;
processing the text using natural language processing (NLP) to detect content; and
transmitting the content to a server,
wherein the server distributes the content to one or more other users.

18. The non-transitory computer-readable storage medium of claim 17, wherein the content includes one or more tags, one or more key words, or a combination thereof determined by the NLP.

19. The non-transitory computer-readable storage medium of claim 18, wherein the apparatus if further caused to perform:
generating a message comprising at least one of an identifier of the device, a sensed location of the device, the one or more tags, the one or more key words, a timestamp, a flag indicating that the message originates from a broadcaster of the CB radio communication, or a combination thereof,
wherein the content is transmitted to the server using the message.

20. The non-transitory computer-readable storage medium of claim 18, wherein the content is transmitted to the server or distributed from the server using a messaging protocol.
